(19) United States
(12) Patent Application Publication
(10) Pub. No.: US 2026/0179490 A1
(43) Pub. Date: Jun. 25, 2026

(54) AUTOMATED VALET PARKING MANAGEMENT SYSTEM, AUTOMATED VALET PARKING MANAGEMENT METHOD, AND NON-TRANSITORY COMPUTER-READABLE RECORDING MEDIUM

(71) Applicant: TOYOTA JIDOSHA KABUSHIKI KAISHA, Toyota-shi (JP)

(72) Inventors: Kazuhito ESHIMA, Toyota-shi (JP); Hidenobu KINUGASA, Nagoya-shi (JP); Takahiro YAMAMOTO, Toyota-shi (JP); Tatsuya SUGANO, Seto-shi (JP)

(73) Assignee: TOYOTA JIDOSHA KABUSHIKI KAISHA, Toyota-shi (JP)

(21) Appl. No.: 19/394,480

(22) Filed: Nov. 19, 2025

(30) Foreign Application Priority Data
Nov. 22, 2024 (JP) 2024-204203

(51) Int. Cl. G08G 1/14; G06T 7/70; G06V 20/52; G06V 40/10

(52) U.S. Cl. CPC G08G 1/141; G06T 7/70; G06V 20/52; G06V 40/10; G06T 2207/30196; G06T 2207/30252; G06V 2201/07; G06V 2201/08

(57) ABSTRACT

When a target vehicle of an automated valet parking is stopped in a drop-off area of a parking lot, an automated valet parking management system executes: user recognition processing of recognizing a position of a user of the target vehicle based on at least one of sensor information and communication information between the target vehicle and a user terminal; and guidance display processing of causing a first display (in-vehicle display) or a second display (e.g., display of the user terminal) to display a guidance display indicating an action that the management system requests the user to take. The guidance display processing includes: selecting one of the first and second displays in accordance with a recognized position of the user; and causing a selected one of the first and second displays to display the guidance display containing specific information that differs depending on the recognized position of the user.

### CROSS-REFERENCES TO RELATED APPLICATION

The present disclosure claims priority under 35 U.S.C. § 119 to Japanese Patent Application No. 2024-204203, filed on Nov. 22, 2024, which is incorporated herein by reference in its entirety.

### BACKGROUND

### Technical Field

The present disclosure relates to a technique for managing automated valet parking (AVP) in a parking lot.

### Background Art

DE 102012222562 A1 discloses a technique related to automated valet parking. A parking lot management system transmits a travel route to a vehicle. The vehicle automatically travels along the acquired travel route.

### SUMMARY

When a vehicle carrying a user arrives at a drop-off area of a parking lot that supports automated valet parking, an automated valet parking management system is needed to clearly notify the user of where and what the user should do to ensure that the automated valet parking can be started smoothly.

An automated valet parking management system according to the present disclosure manages automated valet parking in a parking lot. The automated valet parking management system includes one or more processors configured to execute user recognition processing and guidance display processing when a target vehicle of the automated valet parking is stopped in a drop-off area of the parking lot. The user recognition processing recognizes a position of a user of the target vehicle based on at least one of sensor information and communication information between the target vehicle and a user terminal of the user. The guidance display processing causes a first display or a second display to display a guidance display indicating an action that the automated valet parking management system requests the user to take. The first display is an in-vehicle display of the target vehicle, and the second display is at least one of a display of the user terminal and a display installed in the drop-off area. The guidance display processing includes: selecting one of the first display and the second display in accordance with a recognized position of the user; and causing a selected one of the first display and the second display to display the guidance display containing specific information that differs depending on the recognized position of the user.

An automated valet parking management method according to the present disclosure manages automated valet parking in a parking lot. The automated valet parking management method, which is executed by a computer, includes executing user recognition processing and guidance display processing when a target vehicle of the automated valet parking is stopped in a drop-off area of the parking lot. The user recognition processing recognizes a position of a user of the target vehicle based on at least one of sensor information and communication information between the target vehicle and a user terminal of the user. The guidance display processing causes a first display or a second display to display a guidance display indicating an action that the automated valet parking management system requests the user to take. The first display is an in-vehicle display of the target vehicle, and the second display is at least one of a display of the user terminal and a display installed in the drop-off area. The guidance display processing includes: selecting one of the first display and the second display in accordance with a recognized position of the user; and causing a selected one of the first display and the second display to display the guidance display containing specific information that differs depending on the recognized position of the user.

A non-transitory computer-readable recording medium according to the present disclosure stores an automated valet parking management program executed by a computer for managing automated valet parking in a parking lot. The automated valet parking management program causes the computer to execute user recognition processing and guidance display processing when a target vehicle of the automated valet parking is stopped in a drop-off area of the parking lot. The user recognition processing recognizes a position of a user of the target vehicle based on at least one of sensor information and communication information between the target vehicle and a user terminal of the user. The guidance display processing causes a first display or a second display to display a guidance display indicating an action that the automated valet parking management system requests the user to take. The first display is an in-vehicle display of the target vehicle, and the second display is at least one of a display of the user terminal and a display installed in the drop-off area. The guidance display processing includes: selecting one of the first display and the second display in accordance with a recognized position of the user; and causing a selected one of the first display and the second display to display the guidance display containing specific information that differs depending on the recognized position of the user.

According to the present disclosure, when the target vehicle of the automated valet parking is stopped in the drop-off area of the parking lot, the guidance display accompanied by different specific information depending on the recognized position of the user is displayed on the first display or the second display that is selected depending on the recognized position of the user. Therefore, the automated valet parking management system can clearly notify the user, who has arrived at the drop-off area, of where and what the user should do.

### BRIEF DESCRIPTION OF THE DRAWINGS

FIG. 1 is a conceptual diagram used to describe an overview of an automated valet parking system according to an embodiment;

FIG. 2 is a block diagram showing an example of the configuration of the automated valet parking system according to an embodiment;

FIG. 3 is a flowchart showing an example of the flow of processing related to a guidance display depending on the position of a user according to an embodiment;

FIG. 4 is a flowchart showing an example of the flow of user recognition processing and guidance display processing according to a first specific example;

FIG. 5 is a diagram showing an example of the guidance display in step S402 in FIG. 4;

FIG. 6 is a diagram showing another example of the guidance display in step S402 in FIG. 4;

FIG. 7 is a diagram showing an example of the guidance display in step S404 in FIG. 4;

FIG. 8 is a diagram showing another example of the guidance display in step S404 in FIG. 4;

FIG. 9 is a flowchart showing an example of the flow of the user recognition processing and the guidance display processing according to a second specific example;

FIG. 10 is a diagram showing an example of the guidance display in step S406 in FIG. 9;

FIG. 11 is a diagram showing another example of the guidance display in step S406 in FIG. 9;

FIG. 12 is a flowchart showing an example of the flow of processing related to the guidance display depending on the position of the user and the position of a vehicle;

FIG. 13 is a diagram showing an example of the guidance display in step S700 in FIG. 12;

FIG. 14 is a diagram showing another example of the guidance display in step S700 in FIG. 12;

FIG. 15 is a flowchart showing an example of the flow of processing related to the guidance display depending on the user's position and the vehicle's position and orientation according to an embodiment; and

FIG. 16 is a diagram showing an example of the guidance display in step S900 in FIG. 15.

### DETAILED DESCRIPTION

Embodiments of the present disclosure will be described with reference to the accompanying drawings.

### 1. Overview of Automated Valet Parking System

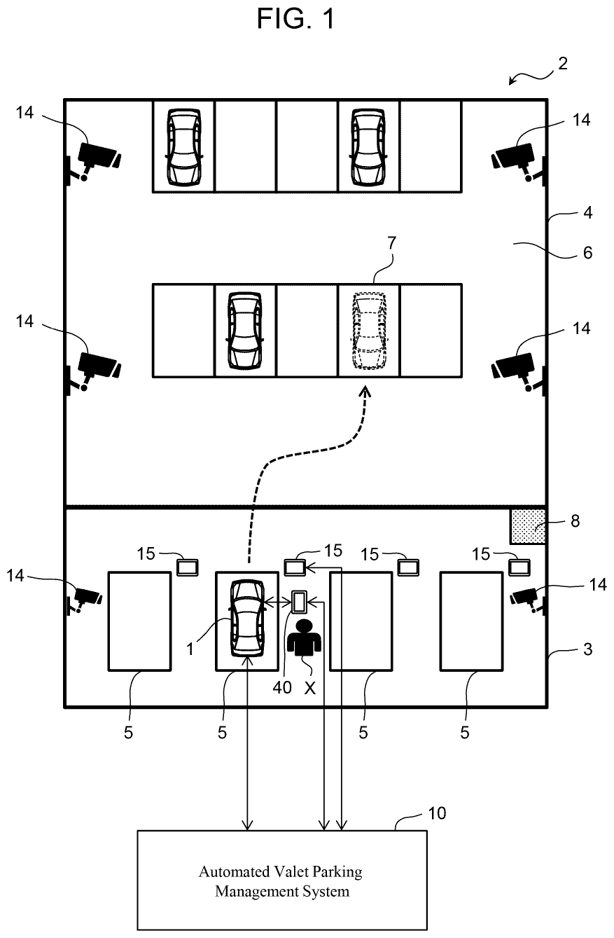

FIG. 1 is a conceptual diagram used to describe an overview of an automated valet parking system 100 according to the present embodiment. The automated valet parking system 100 includes an automated valet parking management system 10 (hereinafter, also simply referred to as a management system 10) and a vehicle system 20 installed in a vehicle 1 and performs automated valet parking (AVP) of the vehicle 1 in a parking lot 2.

The vehicle 1 is configured to be able to execute the AVP in the parking lot 2. That is, the vehicle 1 is a target vehicle of the AVP. The vehicle 1 can travel automatically at least within the parking lot 2 without any driving operation by a user. More specifically, for example, the automated driving of the vehicle 1 within the parking lot 2 is controlled by the management system 10 that utilizes an infrastructure sensor 14. Alternatively, the automated driving may be controlled, for example, by cooperation between the management system 10 and the vehicle system 20. It should be noted that the vehicle 1 may be an automated driving vehicle that is capable of traveling automatically even outside the parking lot 2.

The parking lot 2 includes a drop-off/pick-up area 3 and a parking area 4. The vehicle 1 that enters the parking lot 2 stops at a stopping position (i.e., drop-off/pick-up space) 5 provided in the drop-off/pick-up area 3. At the drop-off/pick-up area 3, the user gets off the vehicle 1. On the other hand, the vehicle 1 that leaves the parking lot 2 stops at the drop-off/pick-up area 3. At the drop-off/pick-up area 3, the user gets on the vehicle 1. In the example shown in FIG. 1, the drop-off area and the pick-up area are provided as the drop-off/pick-up area 3 without distinction between the drop-off and the pick-up, but the drop-off area and the pick-up area may be provided separately. The drop-off area can also be called an entry area, and the pick-up area can also be called an exit area. The parking area 4 includes a passage 6 and a plurality of parking space 7. The passage 6 is an area in which the vehicle 1 travels. The parking space 7 is a space in which the vehicle 1 is parked.

The management system 10 manages the AVP of the vehicle 1 in the parking lot 2. The management system 10 may include, for example, at least one of a local management device installed in the parking lot 2 and a management server on a cloud. An example of a flow when a user X uses automated valet parking service (AVP service) will be described below. The membership information of users is registered in advance in the management system 10.

First, the user X reserves an AVP. For example, the user X operates the user terminal 40 to input information, such as the ID information of the user X, a desired parking lot 2, a desired date of use, and a desired time of use. The user terminal 40 is, for example, a terminal device (e.g., a smartphone) carried by a user. The user terminal 40 transmits reservation information including the input information to the management system 10. The management system 10 executes reservation processing based on the reservation information and transmits a reservation completion notification to the user terminal 40. In addition, the management system 10 transmits the authentication information depending on the reservation information to the user terminal 40. The user terminal 40 receives the authentication information and holds the received authentication information.

Entry (check-in) of the vehicle 1 into the parking lot 2 is as follows. As illustrated in FIG. 1, the vehicle 1 carrying the user X arrives at the drop-off/pick-up area 3 of the parking lot 2 and stops at the stopping position 5. In the drop-off/pick-up area 3, the user X (and other occupants, if any) gets off the vehicle 1.

In order to start the automated driving (i.e., automatic traveling) of the vehicle 1 based on a remote instruction from the management system 10 in the AVP (hereinafter, simply referred to as “AVP driving”), it is necessary to transfer operating authority of the vehicle 1 from the user X to the management system 10. To transfer the operating authority, the user X operates the user terminal 40 to transmit a handover start request to the management system 10. The handover start request is transmitted together with, for example, the authentication information of the user X.

In response to the handover start request transmitted from the user terminal 40, the management system 10 authenticates the user X. When the authentication is completed, the management system 10 starts handover processing (i.e., authority transfer processing) for transferring the operating authority of the vehicle 1 from the user X to the management system 10. The handover processing includes, for example, processing for establishing wireless communication between the management system 10 and the vehicle 1 (vehicle system 20), and processing for identifying the vehicle 1 as the target vehicle for the current AVP.

When the handover processing is completed, the operating authority of the vehicle 1 is transferred from the user X to the management system 10. The management system 10 executes entry processing for the vehicle 1. In the entry processing, the management system 10 communicates with the vehicle 1 and transmits a remote instruction requesting the start-up of a travel system 23 of the vehicle 1 (i.e., turning on the power supply of the travel system 23). The vehicle 1 automatically starts up the travel system 23 in accordance with the received remote instruction. Further, the management system 10 checks the usage status of the parking lot 2, allocates an available parking space 7 to the vehicle 1, and then generates a target route for the vehicle 1 from the drop-off/pick-up area 3 to the allocated parking space 7. Then, the management system 10 communicates with the vehicle 1 and transmits to the vehicle 1 a remote instruction requesting the vehicle 1 to perform the AVP driving along the generated target route toward the parking space 7. The management system 10 also transmits to the vehicle 1 the information about the target route, together with this remote instruction.

In accordance with the target route received from the management system 10, the vehicle 1 performs the AVP driving toward the parking space 7 allocated to the vehicle 1 and automatically parks in the allocated parking space 7 (Entry Completed). After the parking of the vehicle 1 is completed, the management system 10 communicates with the vehicle 1 and transmits a remote instruction requesting to the vehicle 1 to turn off the power supply of the travel system 23. The vehicle 1 automatically turns off the power supply in accordance with the received remote instruction.

Exit (check-out) of the vehicle 1 from the parking lot 2 is as follows. The user X operates the user terminal 40 to transmit to the management system 10, an exit request for leaving the vehicle 1. The exit request includes the authentication information of the user X. In response to the exit request, the management system 10 authenticates the user X. When the authentication is completed, the management system 10 executes exit processing for the vehicle 1.

In the exit processing, the management system 10 communicates with the vehicle 1 and executes a remote instruction requesting the vehicle 1 to start up (i.e., power on) the travel system 23. The vehicle 1 automatically starts up the travel system 23 in accordance with the received remote instruction. Further, the management system 10 generates a target route for the vehicle 1 from the parking space 7 of the vehicle 1 to the drop-off/pick-up area 3. Then, the management system 10 communicates with the vehicle 1 and transmits to the vehicle 1 a remote instruction requesting the vehicle 1 to perform the AVP driving along the generated target route. The management system 10 also transmits to the vehicle 1 the information about the target route, together with this remote instruction.

The vehicle 1 performs the AVP driving toward an allocated pick-up space (drop-off/pick-up space 5) in accordance with the received target route. After the vehicle 1 arrives at the drop-off/pick-up area 3, the user X transmits a handback start request to the management system 10 to transfer (return) the operating authority of the vehicle 1 from the management system 10 to the user X himself/herself. When the handback processing by the management system 10 is completed, the user X (and other occupants, if any) gets on the vehicle 1. The vehicle 1 then departs for the next destination and leaves the parking lot 2 (Exit Completed).

### 2. System Configuration Example

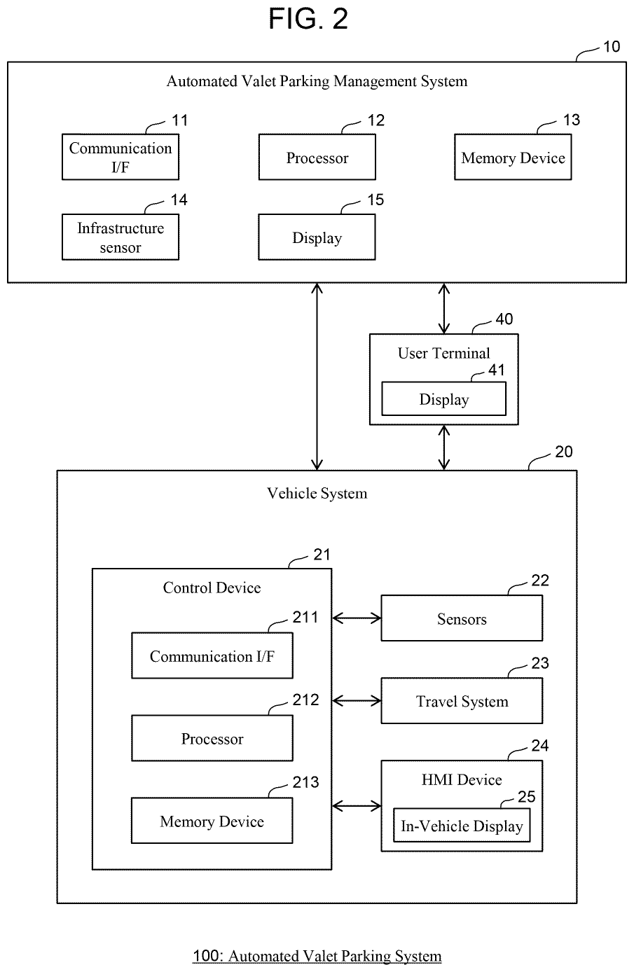

FIG. 2 is a block diagram showing an example of the configuration of the automated valet parking system 100 according to the present embodiment. As described above, the automated valet parking system 100 includes the automated valet parking management system 10 and the vehicle system 20.

### 2-1. Automated Valet Parking Management System

The management system 10 includes a communication interface (communication I/F) 11, one or more processors 12 (hereinafter, simply referred to as a processor 12), one or more memory devices 13 (hereinafter, simply referred to as a memory device 13), one or more infrastructure sensors 14 (hereinafter, simply referred to as an infrastructure sensor 14), and one or more displays 15 (hereinafter, simply referred to as a display 15).

The communication I/F 11 communicates with the vehicle 1 (vehicle system 20) and the user terminal 40 via a communication network.

The processor 12 executes various kinds of processing. Examples of the processor 12 include a general purpose processor, a special purpose processor, a central processing unit (CPU), a graphics processing unit (GPU), an application specific integrated circuit (ASIC), a field-programmable gate array (FPGA), an integrated circuit, a conventional circuit, and/or combinations thereof. The processor 12 may also be referred to as circuitry or processing circuitry. The circuitry is hardware that is programmed to implement the described functions or that executes the functions. The memory device 13 stores various kinds of information. Examples of the memory device 13 include a volatile memory, a non-volatile memory, a hard disk drive (HDD), and a solid state drive (SSD). For example, the memory device 13 stores information about the parking lot 2 (e.g., map information about the parking lot 2, entry and exit time information for each vehicle 1 in the parking lot 2), various kinds of vehicle management information (e.g., vehicle status information indicating the status of the vehicle 1, identification information (vehicle ID) for the vehicle 1), system status information, and user information (e.g., identification information (user ID) for each user, service reservation information). The vehicle status information and the system status information will be described below in detail in Section 3-1.

The functions of the management system 10 may be realized by cooperation between the processor 12 that executes a computer program (corresponding to the “automated valet parking management program” of the present disclosure) and the memory device 13. The computer program is stored in the memory device 13. Alternatively, the computer program may be recorded in a non-transitory computer-readable recording medium or may be provided via a network.

The infrastructure sensor 14 is installed at various locations in the parking lot 2 as shown in FIG. 1. The infrastructure sensor 14 includes, for example, one or more infrastructure cameras, and recognizes the situation of the parking lot 2 including the drop-off/pick-up area 3.

The display 15 is installed in the drop-off/pick-up area 3. More specifically, the display 15 is installed in a location in the drop-off/pick-up area 3 where the display 15 can be seen by the user X who gets out of the vehicle 1. In one example, the display 15 is installed at each drop-off/pick-up space 5.

The management system 10 executes the following processing, for example. That is, the management system 10 uses the infrastructure sensor 14 to grasp the situation of the parking lot 2 (e.g., the position and status of each vehicle 1 in the parking lot 2). The management system 10 allocates a parking space 7 to the vehicle 1. The management system 10 generates a remote instruction, communicates with the vehicle 1, and transmits the generated remote instruction to the vehicle 1. The management system 10 manages the parking lot 2 (e.g., reservation of a parking space 7, entry and exit of the vehicle 1) and the authority to control the traveling of the vehicle 1. The management system 10 manages the authority to remotely operate the vehicle 1 (e.g., authority to operate the power supply of the vehicle 1). The management system 10 communicates with the vehicle 1, collects the vehicle management information described above, and provides various kinds of information (e.g., progress status of the AVP). The management system 10 manages users of the automated valet parking service (AVP service) (including user authentication) and manages reservations for the AVP service made by users.

### 2-2. Vehicle System

The vehicle system 20 is mounted on the vehicle 1 and includes a control device 21, sensors 22, the travel system 23, and one or more HMI (Human Machine Interface) devices 24 (hereinafter, simply referred to as an HMI device 24).

The control device 21 controls the vehicle 1 in accordance with various remote instructions from the management system 10. The control device 21 includes a communication I/F 211, one or more processors 212 (hereinafter, simply referred to as a processor 212), and one or more memory devices 213 (hereinafter, simply referred to as a memory device 213).

The communication I/F 211 communicates with each of the management system 10 and the user terminal 40 via a communication network. An example of the configuration of the processor 212 is the same as that of the processor 12 described above. Moreover, an example of the configuration of the memory device 213 is the same as that of the memory device 13 described above. The functions of the control device 21 may be realized by cooperation between the processor 212 that executes a computer program and the memory device 213. The computer program is stored in the memory device 213. Alternatively, the computer program may be recorded in a non-transitory computer-readable recording medium or may be provided via a network.

The sensors 22 include a recognition sensor, a vehicle state sensor, a position sensor, and an in-vehicle camera, for example. The recognition sensor recognizes (detects) the situation around the vehicle 1. Examples of the recognition sensor include a vehicle exterior camera, a LIDAR (Laser Imaging Detection and Ranging), and a radar. The vehicle state sensor detects the state of the vehicle 1. The vehicle exterior camera is configured to capture an image of the surroundings of the vehicle 1. Examples of the vehicle state sensor include a speed sensor, an acceleration sensor, a yaw rate sensor, and a steering angle sensor. The position sensor detects the position and orientation of the vehicle 1. An example of the position sensor is a Global Navigation Satellite System (GNSS) sensor. The in-vehicle camera is configured to capture an image of the interior of the vehicle 1.

The travel system 23 is a system that operates the vehicle 1. The travel system 23 is, for example, an electric drive system, and includes an electric motor for driving the vehicle 1, a battery for supplying power to the electric motor, and a controller. The travel system 23 may include an internal combustion engine in addition to or instead of the electric motor in order to drive the vehicle 1.

The HMI device 24 exchanges information with the user X who is in the vehicle 1. The HMI device 24 includes an output unit configured to output information to the user X. The HMI device 24 may include an input unit (e.g., a touch panel) through which the user X inputs information. The output unit includes an in-vehicle display 25. For example, the HMI device 24 is a multimedia device or a meter device installed in a passenger compartment of the vehicle 1 (for example, on an instrument panel). That is, the in-vehicle display 25 is, for example, a display of the multimedia device or meter device. Alternatively, the in-vehicle display 25 may be a head-up display (HUD) that displays information on a front windshield 28 of the vehicle 1.

### 3. Guidance Display for User in Drop-Off Area

When the vehicle 1 carrying the user X arrives at the drop-off area of a parking lot that supports the AVP (e.g., the drop-off/pick-up area 3 of the parking lot 2), the management system 10 is needed to clearly notify the user X of where and what the user X should do to ensure that the AVP can be started smoothly.

Accordingly, in the present embodiment, when the target vehicle of the AVP (i.e., the vehicle 1) is stopped in the drop-off area of a parking lot (e.g., the drop-off/pick-up area 3), the management system 10 (processor 12) executes “user recognition processing” and “guidance display processing”.

In the user recognition processing, the management system 10 recognizes the position of the user X based on at least one of sensor information Is and communication information Ic. The communication information Ic is information about the communication between the vehicle 1 and the user terminal 40 of the user X. Then, in the guidance display processing, the management system 10 causes a “first display” or a “second display” to display a “guidance display GD” indicating the action that the management system 10 requests the user X to take.

The first display is the in-vehicle display 25 of the vehicle 1. The second display is, for example, a display 41 of the user terminal 40 (see FIG. 2). The second display may be a display installed in the drop-off area (e.g., display 15 (see FIG. 1)).

The guidance display processing includes selecting one of the first display and the second display in accordance with the position of the user X recognized by the user recognition processing. The guidance display processing also includes displaying, on a selected one of the first and second displays, a guidance display GD containing “specific information SI” that differs depending on the recognized position of the user X.

### 3-1. Guidance Display Depending on Position of User

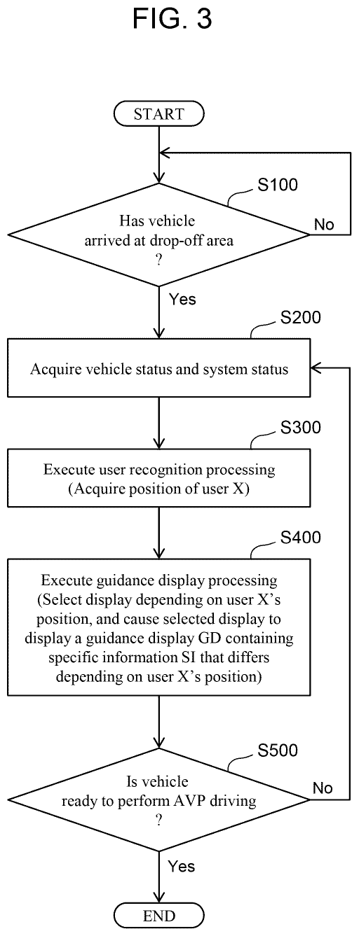

FIG. 3 is a flowchart showing an example of the flow of processing related to the guidance display GD depending on the position of the user X according to the present embodiment. The processing of this flowchart is executed by the processor 12 of the management system 10.

In step S100, the processor 12 determines whether or not the vehicle 1 has arrived at the drop-off/pick-up area 3 (drop/off area). For example, the processor 12 determines that the vehicle 1 has arrived at the drop-off/pick-up area 3 when the processor 12 detects the arrival of the vehicle 1 at the drop-off/pick-up area 3 using the infrastructure sensor 14. Alternatively, the processor 12 may determine that the vehicle 1 has arrived at the drop-off/pick-up area 3 when the processor 12 receives, from the vehicle 1, a notification indicating that the vehicle 1 has stopped at the stop position 5. If the vehicle 1 has arrived at the drop-off/pick-up area 3 (step S100; Yes), the processing proceeds to step S200.

In step S200, the processor 12 acquires the vehicle status information. The vehicle status information acquired in step S200 is information indicating the current status of the vehicle 1 stopped in the drop-off/pick-up area 3. Examples of the status include whether each door of the vehicle 1 is open/closed, whether each window of the vehicle 1 is open/closed, and whether each door is locked/unlocked. For example, the processor 12 acquires the vehicle status information using the infrastructure sensor 14. Alternatively, the processor 12 may communicate with the vehicle 1 and acquire, from the vehicle 1, the vehicle status information acquired at the vehicle 1. In addition, the acquired vehicle status information is stored in the memory device 13.

Furthermore, in step S200, the processor 12 acquires system status information. The system status information acquired in step S200 is information indicating the current status of the management system 10 regarding the provision of the AVP service. Examples of the status include that the vehicle 1 has arrived at the drop-off/pick-up area 3, that the management system 10 is waiting for the handover start request (i.e., AVP start request) from the user X, and that the handover processing is executed. The processor 12 successively updates the system status information based on, for example, the results of the communication between the management system 10 and the user terminal 40 or vehicle 1 and stores the updated system status information in the memory device 13. The processor 12 reads (acquires) the latest system status information from the memory device 13.

In step S300 subsequent to step S200, the processor 12 executes the user recognition processing to acquire the position of the user X in the drop-off/pick-up area 3. Specifically, the processor 12 recognizes (acquires) the position of the user X based on the sensor information Is. Examples of sensor information Is include information about the user X recognized by the infrastructure sensor 14 that captures an image of the drop-off/pick-up area 3, and information about the user X recognized by the sensors 22 (e.g., the vehicle exterior camera or the in-vehicle camera) of the vehicle 1. Alternatively, the processor 12 may acquire (identify) the position of the user X based on the communication information Ic. The communication information Ic is, for example, information on short-range wireless communication (e.g., UWB (Ultra Wideband)) between the vehicle 1 and the user terminal 40. In addition, in order to acquire the position of the user X, the processor 12 may use both the sensor information Is and the communication information Ic.

In step S400 subsequent to step S300, the processor 12 executes the guidance display processing. The guidance display GD in the guidance display processing indicates the action that the management system 10 request the user X to take (in other words, where and what the management system 10 expects the user X to do). Examples of the action include getting out of the vehicle 1, moving to a predetermined location such as a user operation area 8 (see, for example, FIG. 1), making a handover start request, closing doors/windows, locking doors, and staying in the predetermined location until the handover processing is completed. It should be noted that the user operation area 8 mentioned here corresponds to a location provided in or near the drop-off/pick-up area 3 such that the user X can safely use the user terminal 40 to perform an operation regarding the AVP (e.g., an operation to perform the handover start request).

In the guidance display processing, the processor 12 selects a display (the first or second display) on which to display the guidance display GD, in accordance with the position of the user X recognized by the user recognition processing. Specific examples of the display selection will be described below in Section 3-1-1.

Then, in the guidance display processing, the processor 12 causes the selected display to display a guidance display GD containing the specific information SI that differs depending on the recognized position of the user X. Specifically, the processor 12 determines the guidance display GD that is displayed on the selected display, based on, for example, the vehicle status information and system status information together with the position of the user X. Specific examples of the guidance display GD in step S400 and specific examples of the specific information SI included in the guidance display GD will be described below in sections 3-1-1 and 3-1-2.

The guidance display GD includes, for example, one or more of a text, an illustrations (still image), and an animation (moving image). Further, the specific information SI included in the guidance display GD is configured such that, for example, one or more of a text, an illustration, and an animation are included. In addition, if the guidance display GD is made up of a long text, it may be cumbersome for the user X. In contrast, by using an illustration or an animation, the action that the management system 10 expects the user X to take can be naturally expressed in a way that is easy to understand at a glance.

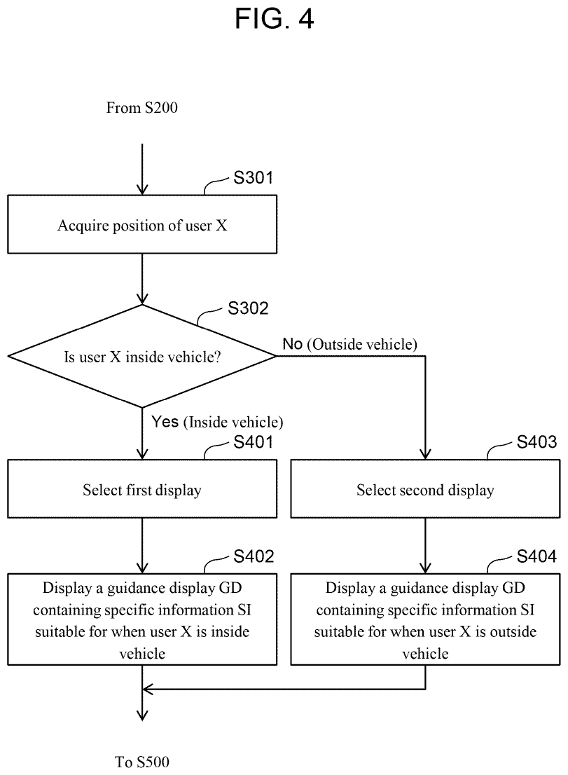

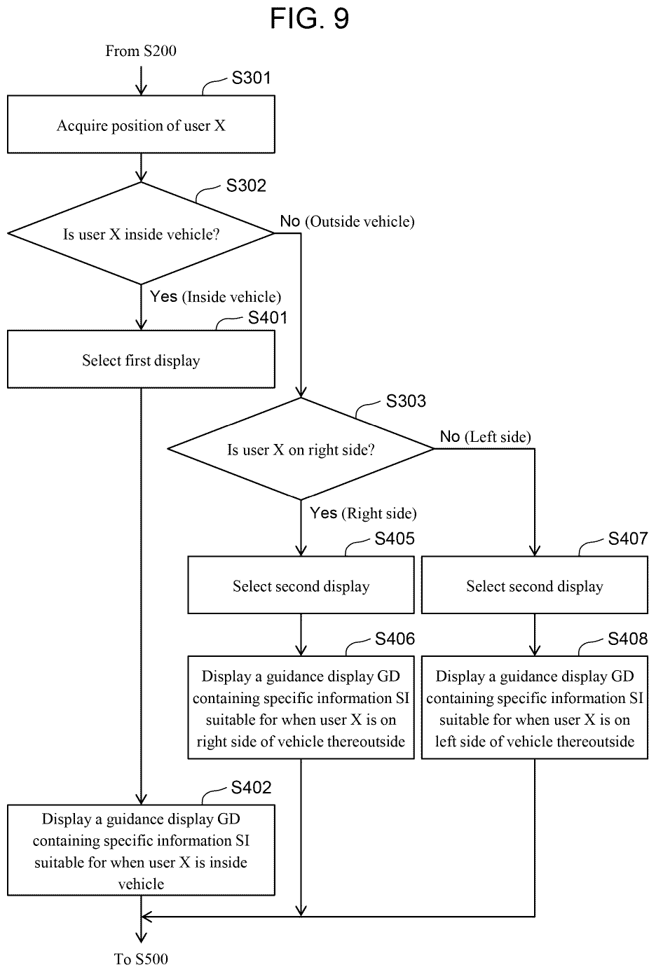

In step S500 subsequent to step S400, the processor 12 determines, based on the system status information, whether or not the vehicle 1 is ready to perform the AVP driving. More specifically, this determination is made, for example, after a predetermined period of time has elapsed since the start of the guidance display GD by the processing of step S400. If the preparation for the AVP driving has not yet been completed (step S500; No), the processor 12 repeatedly executes the processing from step S200 onwards. As a result, the content of the guidance display GD determined in step S400 may be updated based on, for example, the vehicle status information and the system status information, together with the position of the user X when the processing proceeds to step S200 again. For example, the first guidance display GD (see, for example, step S402 in FIG. 4) may be executed before the user X gets out of the vehicle 1, and then the second guidance display GD (see, for example, step S404, S406, or S408 in FIG. 4 or FIG. 9) may be executed after the user X gets out of the vehicle 1. On the other hand, if the preparation for the AVP driving is complete, the processing shown in FIG. 3 ends.

Additionally, the processing shown in FIG. 3 may be modified as follows. That is, when the vehicle 1 arrives at the drop-off/pick-up area 3 (step S100; Yes), the processor 12 may read, from memory device 13, information on the usage history (e.g., number of uses) of the AVP service of the user X of the vehicle 1 that has arrived at the drop-off/pick-up area 3, and acquire the level of proficiency of the user X in using the AVP service based on the usage history. For example, the more times the user X uses the AVP service, the higher the level of proficiency is determined to be. Further, the processor 12 may reduce or simplify the guidance display GD for the user X in accordance with the acquired level of proficiency. More specifically, for example, when the level of proficiency is high, the processor 12 may reduce the number of guidance displays GD that are scheduled from the arrival of the vehicle 1 at the drop-off/pick-up area 3 until the vehicle 1 is ready to perform the AVP driving, compared to when the level of proficiency is low. Reducing the guidance display GD may include not displaying the guidance display GD. Furthermore, simplification of the guidance display GD includes, for example, changing a guidance display GD that uses a combination of a text message and an illustration or animation to a guidance display GD that uses only an illustration or animation.

### 3-1-1. First Specific Example

In the first specific example, the user recognition processing includes identifying whether the user X is inside or outside the target vehicle (vehicle 1). The guidance display processing includes selecting the first display when the user X is inside the vehicle 1 and selecting the second display when the user X is outside the vehicle 1. The guidance display processing further includes changing the specific information SI depending on whether the user X is inside or outside the vehicle 1.

FIG. 4 is a flowchart showing an example of the flow of the user recognition processing and the guidance display processing according to the first specific example. The processing shown in FIG. 4 more specifically represents the user recognition processing (step S300) and the guidance display processing (step S400) in FIG. 3 while reflecting the features of the first specific example. That is, in FIG. 4, the processing of steps S301 and S302 corresponds to the user recognition processing, and the processing of steps S401 to S404 corresponds to the guidance display processing.

In step S301, the processor 12 recognizes (acquires) the position of the user X as described above (see step S300). Then, in step S302, the processor 12 identifies (determines) whether the user X is inside or outside the vehicle 1, based on the recognized position of the user X. Specifically, the determination that the user X is inside the vehicle 1 can be made based on the sensor information Is (e.g., information from the in-vehicle camera) or the communication information Ic. The determination that the user X is outside the vehicle 1 can be made based on, for example, the sensor information Is (e.g., information from the infrastructure sensor 14 or the vehicle exterior camera).

If the user X is inside the vehicle 1, that is, if the user X has not gotten out of the vehicle 1 in the drop-off/pick-up area 3 (step S302; Yes), the processing proceeds to step S401. In step S401, the processor 12 selects the first display (the in-vehicle display 25) as the display destination of the guidance display GD.

In step S402 subsequent to step S401, the processor 12 causes the first display to display a guidance display GD containing the specific information SI suitable for when the user X is inside the vehicle 1. Specifically, for example, the guidance display GD in step S402 is a display that requests the user X to get out of the vehicle 1 and perform an action A1 or A2 based on the recognized position of the user X and the system status information. The action A1 is to move to the predetermined location. For example, if the system status information indicates that the vehicle 1 has arrived at the drop-off/pick-up area 3 but the user X has not yet performed the handover start request, the predetermined location mentioned here corresponds to the user operation area 8. The action A2 is to perform a predetermined action on the vehicle 1 (e.g., closing a door or window, locking a door). The term “door” mentioned here includes not only a door for opening and closing the passenger compartment of the vehicle 1, but also a door for opening and closing the luggage compartment.

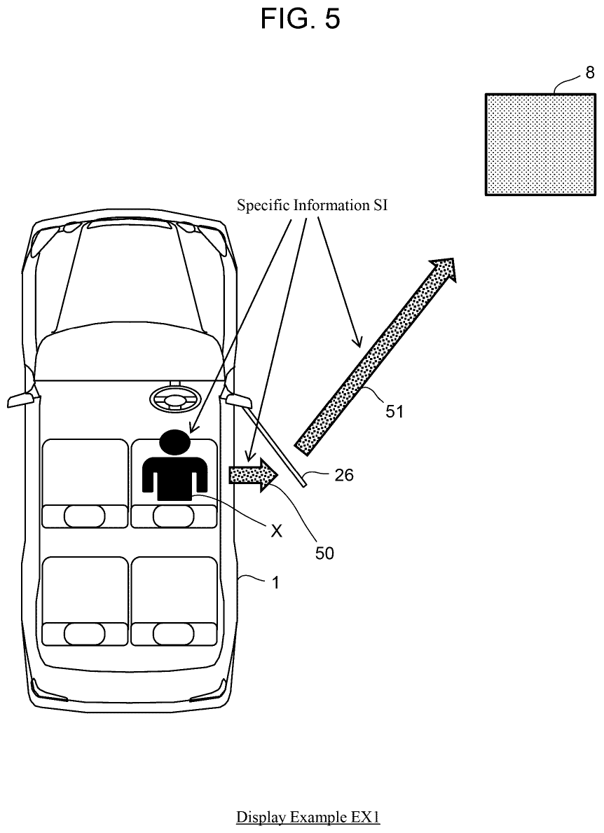

FIG. 5 is a diagram showing an example of the guidance display GD in step S402 in FIG. 4. In a display example EX1 shown in FIG. 5, illustrations including the vehicle 1, the user X, an open door 26, an arrow 50, an arrow 51, and the user operation area 8 are used. This display example EX1 includes specific information SI that “requesting the user X, who is inside the vehicle 1, to get out of the vehicle 1 and move to the predetermined location”, i.e., the specific information SI based on the location of the user X identified in step S302. More specifically, the specific information SI in the display example EX1 includes: an illustration showing that the user X is inside the vehicle 1; an illustration of the arrow 50 that starts from the position of the user X and points outward from the vehicle 1; and an illustration of the arrow 51 that starts from the position where the user X gets out of the vehicle 1 and points toward the user operation area 8.

In addition, the arrow 50 shown in FIG. 5 may be displayed as an animation that moves smoothly from the position of the user X inside the vehicle 1 toward the outside of the vehicle 1. Similarly, the arrow 51 may be displayed as an animation that moves smoothly from the position of the user X when getting out of the vehicle 1 in the direction of the user operation area 8.

Furthermore, the processor 12 may execute the guidance display GD in the display example EX1, for example, as follows. That is, the processor 12 may cause the first display to display an image (vehicle surroundings image) from the vehicle exterior camera (i.e., a camera that captures an image of the surroundings of the vehicle 1) included in the sensors 22. The processor 12 may then superimpose the above-described illustrations included in the guidance display GD (e.g., illustrations including the vehicle 1, the user X, the open door 26, the arrow 50, the arrow 51, and the user operation area 8) on the above-described vehicle surroundings image. This also applies to display examples EX2 to EX8, which will be described below. In addition, in the display examples EX3 to EX7 using the second display (e.g., display 41 or 15), the processing performed by the processor 12 for the superimposed display includes transmitting the above-described vehicle surroundings image from the vehicle 1 to the second display via the management system 10 or directly.

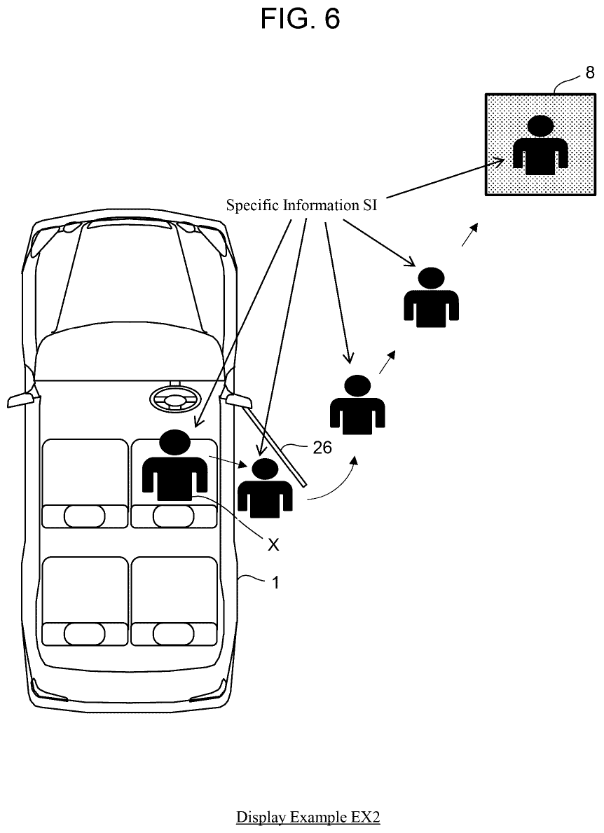

FIG. 6 is a diagram showing another example of the guidance display GD in step S402 in FIG. 4. The display example EX2 shown in FIG. 6 is different from the display example EX1 in that an animation is used instead of the illustrations.

In the display example EX2, as shown in FIG. 6, an animation of the user X (illustration of the user X) getting out of the vehicle 1 and moving toward the user operation area 8 is used. The specific information SI in the display example EX2 includes this animation.

Further, in FIG. 4, if the user X is outside the vehicle 1, that is, if the user X has gotten out of the vehicle 1 in the drop-off/pick-up area 3 (step S302; No), the processing proceeds to step S403. In step S403, the processor 12 selects the second display as the display destination of the guidance display GD. For example, the display 41 of the user terminal 40 is selected as the second display. Alternatively, as the second display, the display 15 installed in the drop-off/pick-up area 3 may be selected, or both the displays 41 and 15 may be selected.

In step S404 subsequent to step S403, the processor 12 causes the second display to display a guidance display GD containing specific information SI suitable for when the user X is outside the vehicle 1. Specifically, for example, the guidance display GD in step S404 is a display that requests the user X, who is getting off the vehicle 1, to perform the above-described action A1 or A2, based on the recognized position of the user X and the system status information indicating that the vehicle 1 has arrived at the drop-off/pick-up area 3.

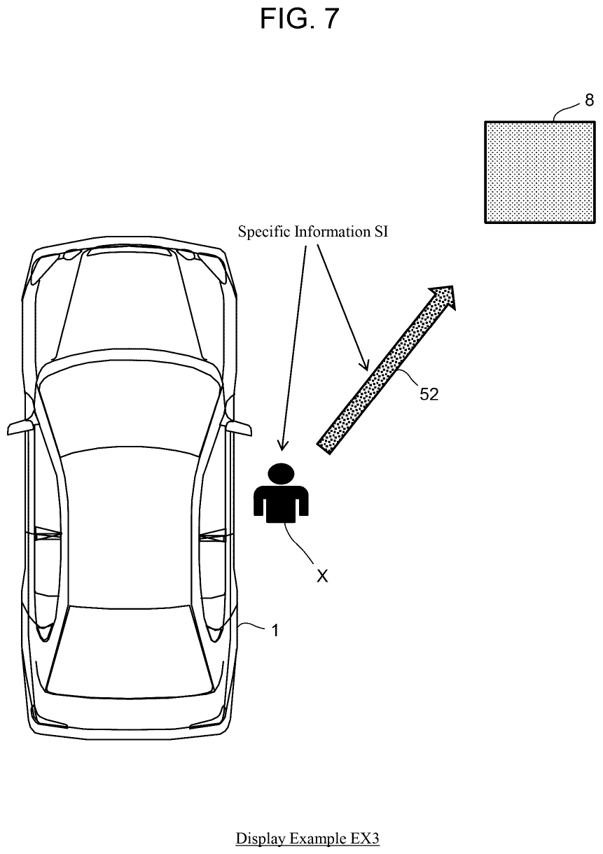

FIG. 7 is a diagram showing an example of the guidance display GD in step S404 in FIG. 4. In the display example EX3 shown in FIG. 7, illustrations including the vehicle 1, the user X, an arrow 52, and the user operation area 8 are used. This display example EX3 includes specific information SI that “requesting the user X, who has gotten out of the vehicle 1, to move to the predetermined location (e.g., user operation area 8)”, i.e., the specific information SI based on the position of the user X identified in step S302. More specifically, the specific information SI in the display example EX3 includes: an illustration showing that the user X has gotten out of the vehicle 1 and is standing beside the vehicle 1; and an illustration of the arrow 52 that starts from the position of the user X outside the vehicle 1 and points toward the user operation area 8.

In addition, the arrow 52 shown in FIG. 7 may be displayed as an animation that moves smoothly from the position of the user X outside the vehicle 1 toward the user operation area 8.

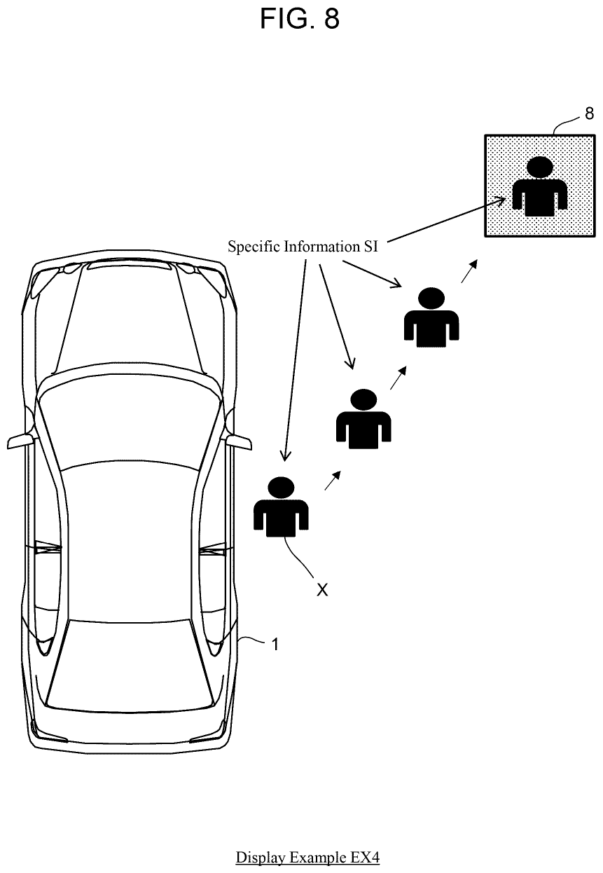

FIG. 8 is a diagram showing another example of the guidance display GD in step S404 in FIG. 4. The display example EX4 shown in FIG. 8 is different from the display example EX3 in that an animation is used instead of the illustrations.

In the display example EX4, as shown in FIG. 8, an animation of the user X moving from beside the vehicle 1 toward the user operation area 8 is used. The specific information SI in the display example EX4 includes this animation.

In addition, in the display examples EX3 and EX4, the position of the user X in the illustration or animation may be fixed on, for example, either the right side or the left side of the vehicle 1 or may change to the right side or the left side of the vehicle 1 in accordance with the determination result in step S303 described below.

### 3-1-2. Second Specific Example

In the second specific example, the user recognition processing includes identifying whether the user X is on the right side or the left side of the target vehicle (vehicle 1) when the user X is outside the vehicle 1. The guidance display processing includes changing the specific information SI depending on whether the user X is on the right side or the left side of the vehicle 1.

FIG. 9 is a flowchart showing an example of the flow of the user recognition processing and the guidance display processing according to the second specific example. The processing shown in FIG. 9 represents the user recognition processing (step S300) and the guidance display processing (step S400) in FIG. 3 in more detail than the first specific example while reflecting the features of the second specific example. That is, in FIG. 9, the processing of steps S301 to S303 corresponds to the user recognition processing, and the processing of steps S401, S402, and S405 to S408 corresponds to the guidance display processing.

In FIG. 9, when the user X is outside the vehicle 1 (step S302; No), the processing proceeds to step S303. In step S303, the processor 12 identifies (determines) whether the user X is on the right side or the left side of the vehicle 1 outside the vehicle 1, based on the recognized position of the user X. Specifically, this determination can be made based on, for example, the sensor information Is (e.g., information from the infrastructure sensor 14 or the vehicle exterior camera).

When the user X is on the right side of the vehicle 1 (step S303; Yes), the processor 12 selects the second display as the display destination of the guidance display GD (step S405). Then, in step S406, the processor 12 causes the second display to display a guidance display GD containing specific information SI suitable for when the user X is on the right side of the vehicle 1 there outside. Specifically, for example, the guidance display GD in step S406 is a display that requests the user X to perform the above-described action A1 or A2 while indicating the direction from the position of the user X who has gotten out of the vehicle 1, based on the recognized position of the user X and the vehicle status information (e.g., opening/closing of a door or window, locking/unlocking of a door).

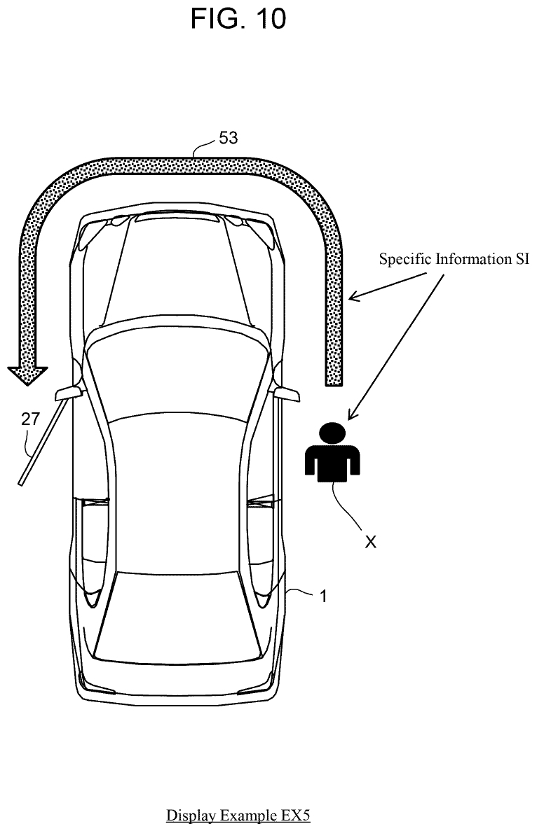

FIG. 10 is a diagram showing an example of the guidance display GD in step S406 in FIG. 9. In a display example EX5 shown in FIG. 10, illustrations including the vehicle 1, the user X, an open left door 27, and an arrow 53 are used. This display example EX5 includes specific information SI that “requesting the user X to close the door 27 on the opposite side (left side) of the vehicle 1”, i.e., the specific information SI based on the position of the user X identified in steps S302 and S303. More specifically, the specific information SI in the display example EX5 includes: an illustration showing that the user X is on the right side of vehicle 1; and an illustration of the arrow 53 that starts from the position of the user X on the right side of vehicle 1, extends around the perimeter of the vehicle 1, and points toward the left door 27. The display example EX5 is similarly applicable to “closing a window” or “locking a door”.

In addition, the arrow 53 shown in FIG. 10 may be displayed as an animation that moves smoothly from the position of the user X on the right side of the vehicle 1 toward the left door 27.

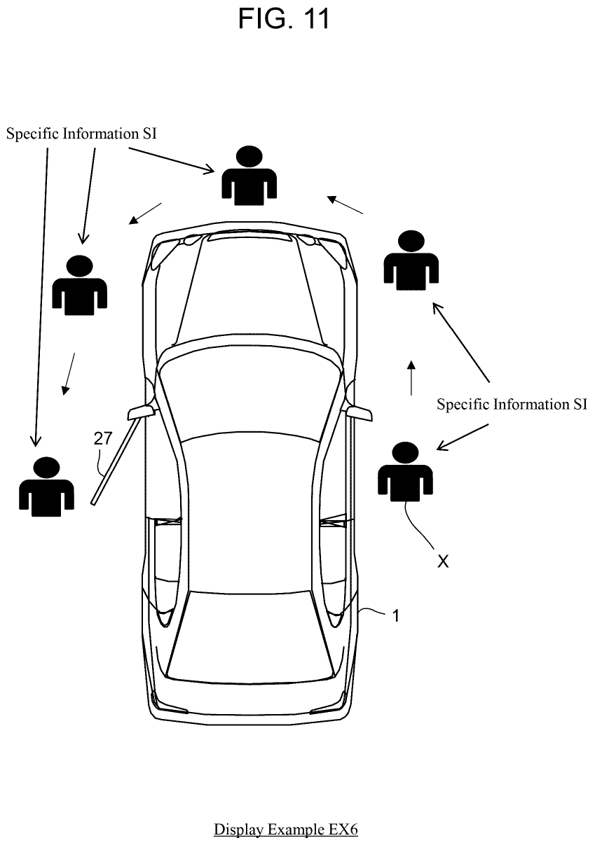

FIG. 11 is a diagram showing another example of the guidance display GD in step S406 in FIG. 9. A display example EX6 shown in FIG. 11 is different from the display example EX5 in that an animation is used instead of the illustrations.

In the display example EX6, as shown in FIG. 11, an animation of the user X moving from the right side of the vehicle 1 toward the left door 27 is used. The specific information SI in the display example EX6 includes this animation. The animation may include an animation of the door 27 that closes after the user X approaches the door 27. The display example EX6 is similarly applicable to “closing a window” or “locking a door”.

Furthermore, in FIG. 9, when the user X is on the left side of the vehicle 1 (step S303; No), the processor 12 selects the second display as the display destination of the guidance display GD (step S407). Then, in step S408, the processor 12 causes the second display to display a guidance display GD containing specific information SI suitable for when the user X is on the left side of the vehicle 1 there outside. A specific example of the guidance display GD in step S408 is similar to the display examples EX5 and EX6 described above, except that the position of the user X in the illustrations or animation is changed to the left side of the vehicle 1 and the open door or window is changed from the left side to the right side of the vehicle 1.

### 3-2. Guidance Display Depending on User's Position and Vehicle's Position

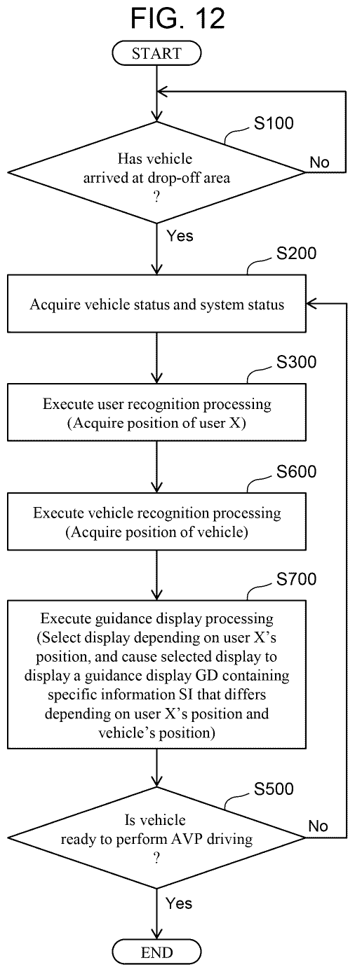

FIG. 12 is a flowchart showing an example of the flow of processing related to the guidance display GD depending on the position of the user and the position of the vehicle. The differences between the processing of this flowchart and the processing of the flowchart shown in FIG. 3 will be described below.

In FIG. 12, the processor 12 executes the user recognition processing similar to the processing shown in FIG. 3 (step S300). The user recognition processing executed here may include the processing of steps S301 and S302 (see FIG. 4) described above and may further include the processing of step S303 (see FIG. 9).

In step S600 subsequent to step S300, the processor 12 executes “vehicle recognition processing” to acquire the position of the target vehicle (e.g., vehicle 1) in the drop-off area (e.g., drop-off/pick-up area 3). Specifically, the processor 12 recognizes (acquires) the position of the vehicle 1 based on the sensor information Is. Examples of the sensor information Is include information about the vehicle 1 recognized by the infrastructure sensor 14 configured to capture an image of the drop-off/pick-up area 3, and information about the vehicle 1 recognized by the sensors 22 (e.g., the position sensor of the vehicle 1, such as the GNSS sensor, or the vehicle exterior camera).

In step S700 subsequent to step S600, the processor 12 executes the guidance display processing. The guidance display processing in step S700 is different from the guidance display processing in step S400 (see FIG. 3) in that the specific information SI is changed depending not only on the position of the user X recognized by the user recognition processing, but also on the position of the vehicle 1 recognized by the vehicle recognition processing.

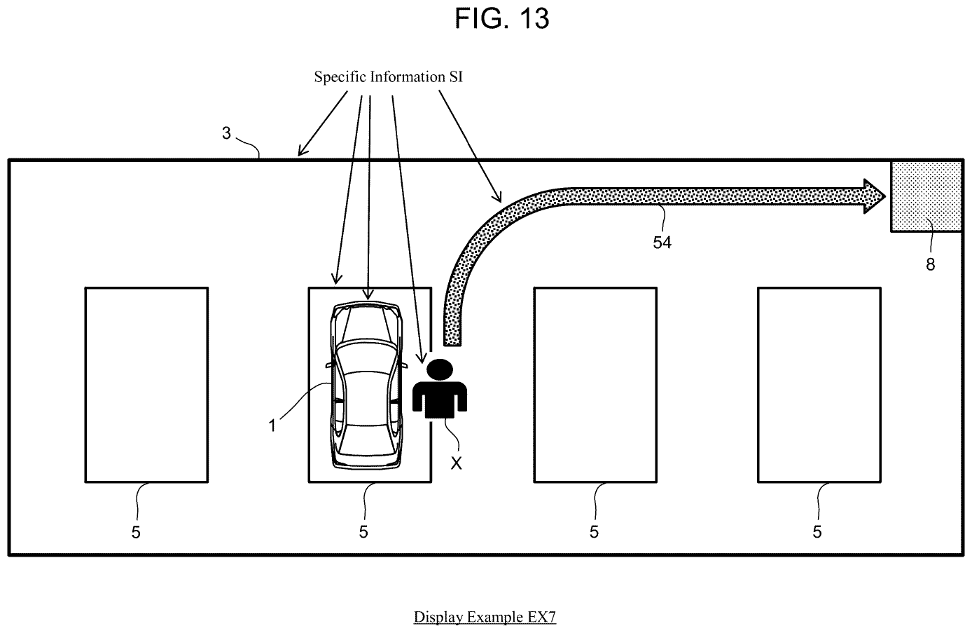

FIG. 13 is a diagram showing an example of the guidance display GD in step S700 in FIG. 12. A display example EX7 shown in FIG. 13 is a display that, similar to the display example EX3 (see FIG. 7), requests the user X, who is recognized as being outside the vehicle 1, to move to the predetermined location (e.g., user operation area 8).

In the display example EX7, illustrations including the vehicle 1, the user X, the user operation area 8, the drop-off/pick-up area 3, and an arrow 54 are used. The drop-off/pick-up area 3 in the illustration includes, for example, illustrations of all the drop-off/pick-up spaces 5 that the drop-off/pick-up area 3 actually has. Further, the specific information SI in the display example EX7 includes: an illustration showing that the user X has gotten out of the vehicle 1 and is standing beside the vehicle 1; an illustration of the arrow 54 that starts from the position of the user X outside the vehicle 1 and points toward the user operation area 8; and an illustration showing that the vehicle 1 is stopped at a drop-off/pick-up space 5 within the drop-off/pick-up area 3 that is represented together with all the drop-off/pick-up spaces 5 (i.e., an illustration showing the specific stopping position 5 of the vehicle 1 within the drop-off/pick-up area 3).

In addition, the arrow 54 shown in FIG. 13 may be displayed as an animation that moves smoothly from the position of the user X outside the vehicle 1 in the direction of the user operation area 8. Alternatively, in the display example EX7, similar to the display example EX4 (see FIG. 8), an animation of the user X moving from beside the vehicle 1 toward the user operation area 8 may be used instead of or in addition to the arrow 54. Furthermore, in the display example EX7, the position of the user X on the illustrations or animation may be fixed, for example, on either the right side or the left side of the vehicle 1 or may change to the right side or the left side of the vehicle 1 in accordance with the determination result in step S303 described above.

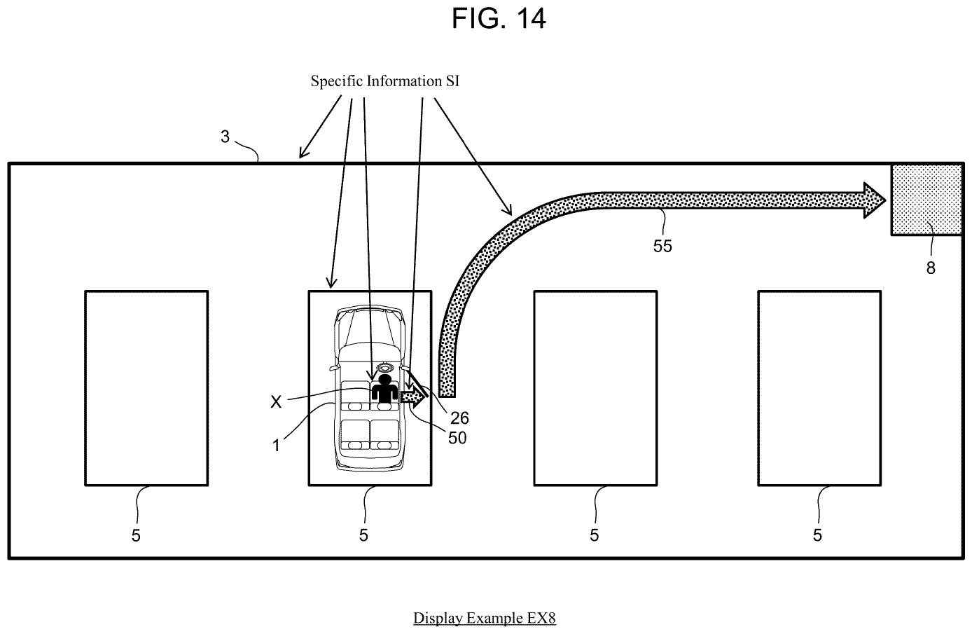

FIG. 14 is a diagram showing another example of the guidance display GD in step S700 in FIG. 12. A display example EX8 shown in FIG. 14 is a display that, similar to the display example EX1 (see FIG. 5), requests the user X, who is recognized as being inside the vehicle 1, to move to the predetermined location (e.g., user operation area 8).

In the display example EX8, illustrations including the vehicle 1, the user X, the user operation area 8, the drop-off/pick-up area 3, the arrow 50, and an arrow 55 are used. Further, the specific information SI in the display example EX8 includes: an illustration showing that user X is inside the vehicle 1; an illustration of the arrow 50 that starts from the position of the user X and points outward from the vehicle 1; an illustration of the arrow 55 that starts from the position where the user X gets out of the vehicle 1 and points toward the user operation area 8; and an illustration showing that the vehicle 1 is stopped at a drop-off/pick-up space 5 within the drop-off/pick-up area 3 that is represented together with all the drop-off/pick-up spaces 5.

In addition, each of the arrows 50 and 55 shown in FIG. 14 may be displayed as an animation as described above in the display example EX1 (see FIG. 5). Alternatively, in the display example EX8, similar to the display example EX2 (see FIG. 6), an animation of the user X moving from beside the vehicle 1 toward the user operation area 8 may be used instead of or in addition to the arrow 55.

### 3-3. Guidance Display Depending on User's Position and Vehicle's Position and Orientation

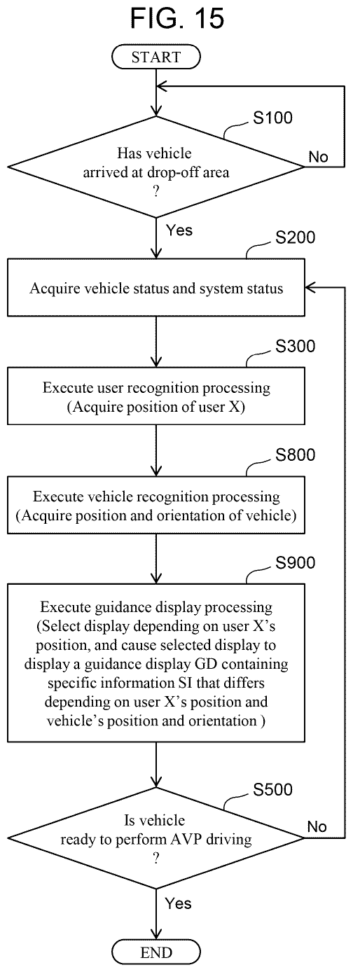

FIG. 15 is a flowchart showing an example of the flow of processing related to the guidance display GD depending on the user's position and the vehicle's position and orientation according to the present embodiment. The differences between the processing of this flowchart and the processing of the flowchart shown in FIG. 12 will be described below. The following two orientations when the vehicle 1 stops at a drop-off space (e.g., drop-off/pick-up space 5) corresponds to examples of the “orientation” of the vehicle 1 mentioned here. One of the two orientations is the orientation when the vehicle 1 moves forward from a direction and stops, and The other is the orientation when the vehicle 1 moves backward and stops.

In FIG. 15, the processor 12 executes the user recognition processing (step S300) similar to the processing shown in FIG. 12 and then executes vehicle recognition processing (step S800). The vehicle recognition processing in step S800 is different from the vehicle recognition processing in step S600 in that not only the position of the target vehicle (e.g., vehicle 1) but also the orientation of the target vehicle is acquired. Specifically, the processor 12 recognizes (acquires) the position and orientation of the vehicle 1 based on the sensor information Is. Examples of the sensor information Is used to recognize the orientation of the vehicle 1 include information about the vehicle 1 recognized by the infrastructure sensors 14 configured to capture an image of the drop-off/pick-up area 3, and information about the vehicle 1 recognized by the sensors 22 (e.g., the vehicle exterior camera).

In step S900 subsequent to step S800, the processor 12 executes the guidance display processing. The guidance display processing in step S900 is different from the guidance display processing in step S700 (see FIG. 12) in that the specific information SI is changed depending not only on the position of the user X and the position of the vehicle 1 respectively recognized by the user recognition processing and the vehicle recognition processing, but also on the orientation of the vehicle 1 recognized by the vehicle recognition processing.

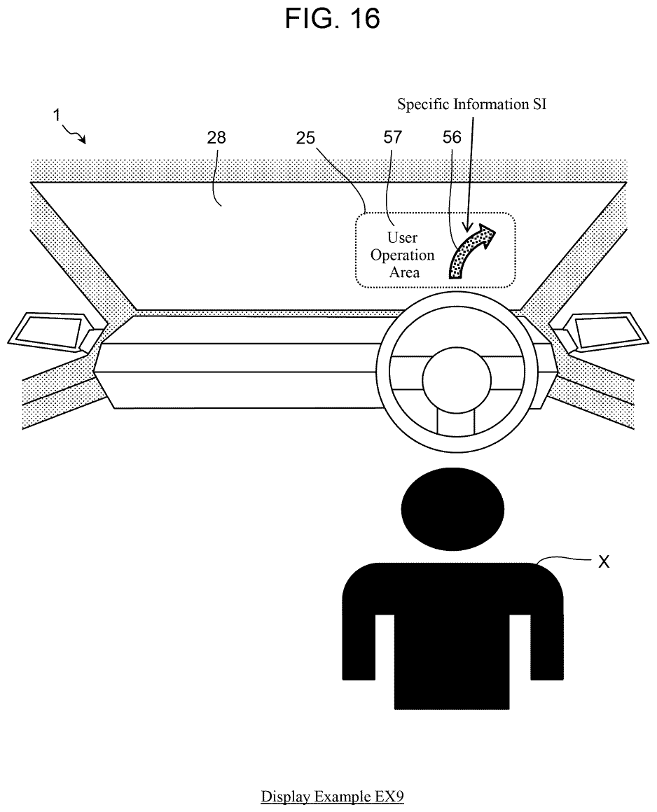

FIG. 16 is a diagram showing an example of the guidance display GD in step S900 in FIG. 15. A display example EX9 shown in FIG. 16 is a display that, similar to the display example EX8 (see FIG. 14), requests the user X, who is recognized as being inside the vehicle 1, to move to the predetermined location (e.g., user operation area 8). In the display example EX9, as shown in FIG. 16, the guidance display GD is displayed on the in-vehicle display 25 (second display), which is a head-up display using the front windshield 28, for example.

In the display example EX9, illustrations of an arrow 56 and a text message 57 (text) are used. It is assumed herein that the actual user operation area 8 is located at the right front of the vehicle 1. The specific information SI in the display example EX9 includes an illustration of the arrow 56 displayed on the in-vehicle display 25 pointing in the direction of the user operation area 8 located at the right front of the vehicle 1 when the user X sitting in the driver's seat looks ahead of the vehicle 1 as shown in FIG. 16. The text message 57 is a display that complements the arrow 56. The text message 57 is, for example, “User Operation Area” shown in FIG. 16, or “Please move to the user operation area”. In addition, according to the processing of step S900, the direction of the arrow 56 is determined and displayed so as to change depending on the position and orientation of the vehicle 1 recognized by the vehicle recognition processing (see step S800).

In addition, the arrow 56 shown in FIG. 16 may be displayed as an animation that moves smoothly in the direction of the user operation area 8. Alternatively, in the display example EX9, an animation in which an illustration in the shape of a person moves in the direction of the user operation area 8 may be used instead of or in addition to the arrow 56.

In another example of the guidance display GD in step S900, the processor 12 determines the shape and direction of an arrow, such as the arrow 54 used in the display example EX7 shown in FIG. 13, based not only on the position of the vehicle 1 but also on the orientation thereof (i.e., recognized orientation). Further, depending on the recognized orientation, the processor 12 changes the orientation of the vehicle 1 (the orientation of the vehicle 1 relative to the drop-off/pick-up space 5) or the position of the user X's destination (e.g., the user operation area 8) displayed on the second display such that the orientation of the vehicle 1 or the position of the user X's destination matches the actual positional relation between the vehicle 1 and the destination.

In yet another example of the guidance display GD in step S900, the processor 12 determines the shape and direction of an arrow, such as the arrow 55 used in the display example EX8 shown in FIG. 14, based not only on the position of the vehicle 1 but also on the orientation thereof (i.e., recognized orientation). Further, depending on the recognized orientation, the processor 12 changes the orientation of the vehicle 1 or the position of the user X's destination displayed on the first display such that the orientation of the vehicle 1 or the position of the user X's destination matches the actual positional relation between the vehicle 1 and the destination.

### 4. Effect

As described above, according to the automated valet parking management system 10 of the present embodiment, when the vehicle 1 is stopped in the drop-off area (e.g., drop-off/pick-up area 3), the guidance display GD accompanied by different specific information SI (real-time information) depending on “the recognized position of the user X” is displayed on the first or second display that is appropriately selected depending on “the recognized position of the user X”. Therefore, the automated valet parking management system 10 can clearly notify the user X, who has arrived at the drop-off/pick-up area 3, of where and what the user X should do.

Moreover, the display location (first or second display) of the guidance display GD and the specific information SI in the present embodiment may be changed depending on whether the user X is inside or outside the vehicle 1 (see FIGS. 4 to 8). This allows real-time information including a more specific current location of the user X to be transmitted to the user X as the specific information SI via the first or second display appropriately selected depending on the recognized specific location of the user X. Therefore, the automated valet parking management system 10 can provide the guidance display GD that is easier for the user X to understand.

Moreover, the specific information SI included in the guidance display GD in the present embodiment may be changed depending on whether the user X is on the right side or the left side of the vehicle 1 outside the vehicle 1 (see FIGS. 9 to 11). This allows real-time information including an even more specific current location of the user X relative to the vehicle 1 to be transmitted to the user X as the specific information SI. As a result, the guidance display GD that is even easier for the user X to understand can be provided.

Moreover, the specific information SI included in the guidance display GD in the present embodiment may be changed depending not only on the recognized position of the user X, but also on “the recognized position of the vehicle 1” (see FIGS. 12 to 14). This allows real-time information further including the specific current position of the vehicle 1 in the drop-off/pick-up area 3 to be transmitted to the user X as the specific information SI. As a result, the guidance display GD that is even easier for the user X to understand can be provided.

Furthermore, the specific information SI included in the guidance display GD in the present embodiment may be changed depending not only on the recognized position of the user X, but also on “the recognized position and orientation of the vehicle 1” (see FIGS. 15 and 16). This allows real-time information further including a more accurate position of the vehicle 1 in the drop-off/pick-up area 3 to be transmitted to the user X as the specific information SI. As a result, the guidance display GD that is even easier for the user X to understand can be provided. In addition, in the display example EX9 (see FIG. 16), which uses a head-up display as the second display, the actual scenery and the specific information SI (e.g., arrow 56) are superimposed. Therefore, the user X can more easily grasp the destination of the user X (e.g., user operation area 8) that is requested by the management system 10.

What is claimed is:

1. An automated valet parking management system for managing automated valet parking in a parking lot,
the automated valet parking management system comprising processing circuitry configured to execute user recognition processing and guidance display processing when a target vehicle of the automated valet parking is stopped in a drop-off area of the parking lot, wherein
the user recognition processing recognizes a position of a user of the target vehicle based on at least one of sensor information and communication information between the target vehicle and a user terminal of the user,
the guidance display processing causes a first display or a second display to display a guidance display indicating an action that the automated valet parking management system requests the user to take,
the first display is an in-vehicle display of the target vehicle, and the second display is at least one of a display of the user terminal and a display installed in the drop-off area, and
the guidance display processing includes:
selecting one of the first display and the second display in accordance with a recognized position of the user; and
causing a selected one of the first display and the second display to display the guidance display containing specific information that differs depending on the recognized position of the user.

2. The automated valet parking management system according to claim 1, wherein
the user recognition processing includes identifying whether the user is inside or outside the target vehicle, and
the guidance display processing includes:
selecting the first display when the user is inside the target vehicle, and selecting the second display when the user is outside the target vehicle; and
changing the specific information depending on whether the user is inside or outside the target vehicle.

3. The automated valet parking management system according to claim 2, wherein
the user recognition processing includes identifying whether the user is on a right side or a left side of the target vehicle when the user is outside the target vehicle, and
the guidance display processing includes changing the specific information depending on whether the user is on the right side or the left side of the target vehicle.

4. The automated valet parking management system according to claim 1, wherein
the processing circuitry is further configured to execute vehicle recognition processing of recognizing a position of the target vehicle in the drop-off area based on the sensor information, and
the guidance display processing includes changing the specific information depending on a recognized position of the target vehicle.

5. The automated valet parking management system according to claim 4, wherein
the vehicle recognition processing includes recognizing an orientation of the target vehicle, and
the guidance display processing includes changing the specific information depending on recognized position and orientation of the target vehicle.

6. The automated valet parking management system according to claim 1, wherein
the guidance display includes at least one of an illustration and an animation.

7. An automated valet parking management method for managing automated valet parking in a parking lot,
the automated valet parking management method, which is executed by a computer, comprising executing user recognition processing and guidance display processing when a target vehicle of the automated valet parking is stopped in a drop-off area of the parking lot, wherein
the user recognition processing recognizes a position of a user of the target vehicle based on at least one of sensor information and communication information between the target vehicle and a user terminal of the user,
the guidance display processing causes a first display or a second display to display a guidance display indicating an action that the automated valet parking management system requests the user to take,
the first display is an in-vehicle display of the target vehicle, and the second display is at least one of a display of the user terminal and a display installed in the drop-off area, and
the guidance display processing includes:
selecting one of the first display and the second display in accordance with a recognized position of the user; and
causing a selected one of the first display and the second display to display the guidance display containing specific information that differs depending on the recognized position of the user.

8. A non-transitory computer-readable recording medium storing an automated valet parking management program executed by a computer for managing automated valet parking in a parking lot,
the automated valet parking management program causing the computer to execute user recognition processing and guidance display processing when a target vehicle of the automated valet parking is stopped in a drop-off area of the parking lot, wherein
the user recognition processing recognizes a position of a user of the target vehicle based on at least one of sensor information and communication information between the target vehicle and a user terminal of the user,
the guidance display processing causes a first display or a second display to display a guidance display indicating an action that the automated valet parking management system requests the user to take,
the first display is an in-vehicle display of the target vehicle, and the second display is at least one of a display of the user terminal and a display installed in the drop-off area, and
the guidance display processing includes:
selecting one of the first display and the second display in accordance with a recognized position of the user; and
causing a selected one of the first display and the second display to display the guidance display containing specific information that differs depending on the recognized position of the user.
